(19) United States
(12) Patent Application Publication
(10) Pub. No.: US 2014/0012596 A1
(43) Pub. Date: Jan. 9, 2014

(54) PORTABLE DEVICE FOR STORING PERSONAL HEALTH RECORD AND METHOD FOR CONTROLLING THE SAME

(71) Applicants: Yoon Nyun Kim, Daegu (KR); Hyo Chan Jeon, Daegu (KR); Kyu Tae Choi, Daegu (KR)

(72) Inventors: Yoon Nyun Kim, Daegu (KR); Hyo Chan Jeon, Daegu (KR); Kyu Tae Choi, Daegu (KR)

(73) Assignee: MDWARE CO., LTD, Daegu (KR)

(21) Appl. No.: 13/392,854

(22) PCT Filed: Mar. 10, 2011
(86) PCT No.: PCT/KR11/01694

§ 371 Date: Jun. 18, 2012

(30) Foreign Application Priority Data
Mar. 10, 2011 (KR) 10-2011-0021376
Mar. 10, 2011 (KR) 10-2011-0021580

(51) Int. Cl. G06F 19/00

(52) U.S. Cl. CPC G06F 19/323
USPC 705/3

(57) ABSTRACT

The present invention relates to a portable device for storing personal health records and a method for controlling the same, and more particularly, to a portable device for storing personal health records and a method for controlling the same in which user authentication is performed in order to personally manage health records and utilization of data is selected according to a result of the user authentication.

A portable device for storing a personal health record includes: a connection unit configured to be connected to a personal terminal and provide paths for supplying power and transmitting data; a main substrate configured to be connected to the connection unit, fix a plurality of elements, and transmit electric signals through a printed circuit; a security module configured to be mounted on the main substrate, and determine whether a user is authorized based on biometric information of the user; a communication module configured to be mounted on the main substrate, receive measurement data by means of near field communication from a measurement device measuring a health condition of an individual; a storage module configured to be mounted on the main substrate and store data; and a control module configured to control the main substrate and each of the modules, wherein the storage module includes: a public storage module configured to store data inputted by an authorized user; and a private storage module configured to store the measurement data received from the communication module.

### TECHNICAL FIELD

The present disclosure relates to a portable device for storing a personal health record and a method for controlling the same, and more particularly, to a portable device for storing a personal health record and a method for controlling the same in which user authentication is performed in order to personally manage the health record and utilization of data is selected according to a result of the user authentication.

### BACKGROUND ART

A personal health record includes a medical record on medical treatment in a hospital where medical experts practice, and in a broader range of a health record, also includes a health related record on blood glucose and blood pressure tested in a home by each individual, and an individual life record on drinking and smoking.

The personal health record includes individual disease-related information and a variety of personal information. Moreover, an amount of data regarding a personal health record becomes drastically increased because diverse treatments are taken as medical technology is rapidly advancing.

Meanwhile, as data storage technology advances, various types of storage devices, more specifically, portable storage devices for personally storing and carrying data are being developed.

One of the most typical portable storage devices is a device called a universal serial bus (USB) memory. Such a storage device provided with a USB interface is easy to carry and easily connectable to a PC, and is thus widely used.

However, when a personal health record is stored in a portable storage device, personal information may be leaked. Therefore, the personal health record should be appropriately protected for privacy protection.

### DISCLOSURE OF THE INVENTION

### Technical Problem

Embodiments provide a portable device for storing a personal health record in which data on the personal health record are easily manageable.

Embodiments also provide a portable device for storing a personal health record in which utilization of stored data is restricted by a multi-level security module.

### Technical Solution

In one embodiment, a portable device for storing a personal health record includes: a connection unit configured to be connected to a personal terminal and provide paths for supplying power and transmitting data; a main substrate configured to be connected to the connection unit, fix a plurality of elements, and transmit electric signals through a printed circuit; a security module configured to be mounted on the main substrate, and determine whether a user is authorized based on biometric information of the user; a communication module configured to be mounted on the main substrate, receive measurement data by means of near field communication from a measurement device measuring a health condition of an individual; a storage module configured to be mounted on the main substrate and store data; and a control module configured to control the main substrate and each of the modules, wherein the storage module includes: a public storage module configured to store data inputted by an authorized user; and a private storage module configured to store the measurement data received from the communication module.

In another embodiment, a method for controlling a portable device for storing a personal health record includes: comparing biometric information inputted for user authentication with biometric information stored in a security module mounted on a main substrate; permitting functions of read and write when the inputted biometric information matches the biometric information stored in the security module and the user authentication is successful so that private data stored in the storage module and public data are allowed to be used, wherein the private data are transmitted from a measurement device measuring a biometric signal to a communication module by means of wireless communication to be stored in the storage module; and permitting the function of read if the inputted biometric information does not match the biometric information stored in the security module and the user authentication fails.

### Advantageous Effects

According to the portable device for storing the personal health record and the method for controlling the same, the scope of the use of data is selectively delimited according to a result of the user authentication.

Therefore, the personal health record can be prevented from being leaked, and thus the personal health record can be safely carried and managed.

Further, since the personal health record can be carried, applicability and usability thereof can be improved.

### BRIEF DESCRIPTION OF THE DRAWINGS

FIG. 1 is a perspective view illustrating an outward appearance of a portable device for storing a personal health record according to an embodiment.

FIG. 2 is a block diagram illustrating an internal configuration of the portable device for storing a personal health record according to the embodiment.

FIG. 3 is a flow chart illustrating operations of the portable device for storing the personal health record according to the embodiment.

FIG. 4 is a flowchart illustrating the operations of the portable device for storing the personal health record according to the embodiment when the portable storage device is used for the first time.

FIG. 5 is a flowchart illustrating operations of the portable device for storing the personal health record in which user authentication is performed in multiple stages according to the embodiment.

FIG. 6 is a flowchart illustrating operations of the portable device for storing the personal health record according to another embodiment.

### MODE FOR CARRYING OUT THE INVENTION

Hereinafter, a portable device for storing a personal health record and a method for controlling the same according to embodiments will be described with reference to the accompanying drawings.

However, the scope of the present invention is not limited to embodiments below, and those skilled in the art may easily suggest other embodiments besides the embodiments below, but the other embodiments are also construed as being in the same technical scope of the present invention.

Furthermore, terms used in the specification or claims are selected for convenience of description, and thus, should be appropriately interpreted in correspondence to the technical scope of the present invention as understanding the technical contents of the present invention.

Further, in this disclosure, a universal serial bus (USB)-type storage device is exemplarily used as a portable device for storing a personal health record.

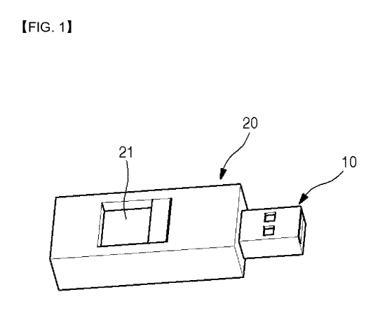

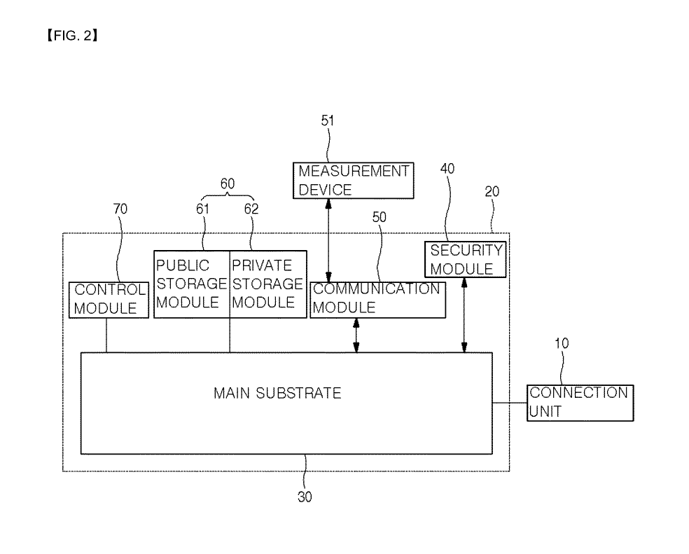

FIG. 1 is a perspective view illustrating an outward appearance of a portable device for storing a personal health record according to an embodiment, and FIG. 2 is a block diagram illustrating an internal configuration of the portable device for storing a personal health record according to the embodiment.

Referring to FIGS. 1 and 2, the portable device for storing a personal heath record according to the embodiment includes a connection unit 10 which is fit to an external terminal to be connected thereto, and a main body 20 in which a plurality of elements are installed.

The connection unit 10 is roughly shaped like a rectangular parallelepiped, and is fit to a terminal owned by a user so as to be connected to the terminal.

A port contacting the terminal is formed in the connection unit 10 to transfer data and supply power. This port provides a path for the data transfer and power supply.

As a matter of course, the terminal owned by the user has a connection port fit to the connection unit 10. As the connection unit 10 is fit to this connection port, the port contacts the connection port so that the power of the terminal is supplied to the main body 20 through the connection unit 10.

Any type of terminal capable of supplying power to the main body 20 may be used. However, it is preferable that the terminal is capable of storing the data stored in the main body 20 through the connection unit 10 or capable of communication.

This is for storing the data stored in the main body 20 or transmitting the data to other storage devices when the data are transferred from the terminal by virtue of the power of the terminal.

Therefore, for instance, a portable terminal capable of storing and transmitting data such as a PDA, smartphone, or portable computer may be used as the terminal.

Herein, if the connection port of the terminal is not fittable to the connection unit 10, the connection port may be connected to the connection unit 10 by using a connecting cable or the like.

Further, the main body 20 has a certain volume and is roughly shaped like a rectangular parallelepiped. An information recognition unit 21 for biometric recognition for user authentication is arranged on an upper surface of the main body 20 in terms of view in the drawing.

The information recognition unit 21 is exposed on the outer surface of the main body 20 so that the user may easily enter biometric information for the user authentication. Various types of biometric information such as fingerprints, iris patterns, and gene structures may be inputted through the information recognition unit 21.

The inner configuration of the main body 20 will be described with reference to FIG. 2. A main substrate 30, which is connected to the connection unit 10 and transmits electric signals through a printed circuit, is fixed in the main body 20.

The main substrate 30 is formed in the shape of a square board having a certain thickness, fixes a plurality of elements, and transmits electric signals through the printed circuit.

A security module 40, which receives the biometric information of the user to determine whether the user is authorized, is fixed to the main substrate 30. The security module 40 is such fixed so that at least one side thereof is exposed through the outer surface of the main body 20.

The at least one side of the security module 40 which is exposed through the outer surface of the main body 20 performs a function of the information recognition unit 21 which receives the biometric information of the user. As a matter of course, the security module 40 may also be such configured as to be disposed in the inside of the main body 20 and receive the biometric information of the user from the information recognition unit 21.

In the embodiment, the security module 40 is exemplarily configured so that the at least one side thereof is exposed through the outer surface of the main body 20 to perform the function of the information recognition unit 21.

A communication module 50, which receives biometric measurement data from a measurement device 51 existing at the outside of the main body 20 by using a near field communication technique, is fixed to the main substrate 30.

The measurement device 51 measures the biometric information of the user who owns the main body 20. The biometric information may include blood pressure, blood glucose, weight, and the like. It is preferable that the measurement device 51 is capable of wirelessly transmitting data to the communication module 50.

That is, the measurement device 51 is provided with a transmission unit which is capable of transmitting the measurement data by using a near field communication technique such as Bluetooth or Zigbee, and the measurement data on the personal health are transmitted to the communication module 50 through the transmission unit.

Further, a storage module 60 for storing data is fixed to the main substrate 30. The storage module 60 consists of a flash memory capable of maintaining data without being supplied with power, and includes a public storage module 61 for storing data inputted by an authorized user and a private storage module 62 for storing the measurement data received from the communication module 50.

The public storage module 61 stores personal health records including general health-related information such as name, age, gender, height, blood type, weight, and the like.

Herein, the public storage module 61 stores data which can be used in an emergency, for example, data on personal chronic symptoms or diseases, medicines taken, and allergies.

As described above, the personal health record stored in the public storage module 61 includes physical information which can be disclosed and is useful in an emergency so that emergency treatment may be rapidly given to an individual without unnecessary treatment, thereby improving efficiency of the emergency treatment.

The communication module 50 and the storage module 60 are such configured as to transmit and receive data to and from the main substrate 30 by using a serial port technique. More specifically, RS-232 technique is used for transmitting and receiving data.

Further, a control unit 70 for controlling the security module 40, the communication module 50, and the storage module 60 is fixed to the main substrate 30.

The control module 70 compares a biometric signal input from the security module 40 with prestored biometric information to determine whether the user is authorized. When it is determined that the inputted biometric signal matches the prestored biometric information, the control module 70 regards the user as an authorized user and allows the user to perform data read and write operations on the whole storage module 60.

When it is determined that the inputted biometric signal does not match the prestored biometric information, the control module 70 regards the user as an unauthorized user and allows the user to perform data read and write operations on the public storage module 61.

Meanwhile, the storage module 60 may further store an application program for managing the personal health record. The application program implements a web-based interface for the user to easily manage the personal health record.

That is, for the user to easily manage the personal health record wherever internet access is possible, the application program provides the wed-based interface.

Further, a smartphone application program may also be provided so that the user easily manages the personal record by using a smartphone.

When the web-based interface is implemented, the user familiar to the internet may easily manage the personal health record. That is, when the user performs the user authentication operation by accessing a website on the internet, the data stored in the storage module 60 are stored into a personal computer, personal phone, another terminal, or web server.

Since the data stored in the storage module 60 are stored into the personal computer, personal phone, another terminal, or web server, even when the portable device for storing the personal health record is lost, the data may be downloaded and utilized by using another portable storage device.

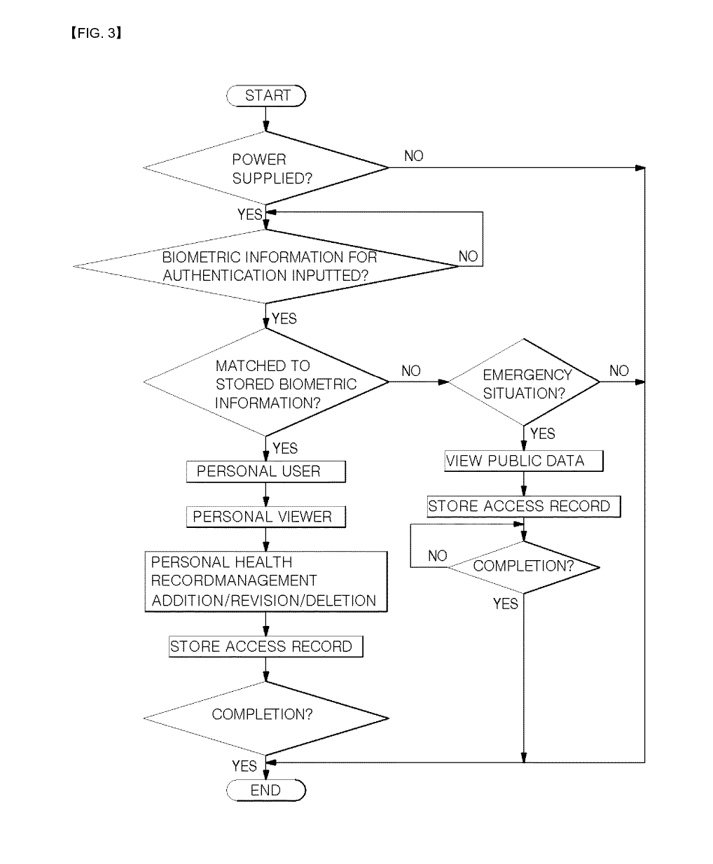

Hereinafter, the method for controlling the portable device for storing the personal health record will be described with reference to FIG. 3.

FIG. 3 is a flowchart illustrating the method for controlling the portable device for storing the personal health record according to an embodiment.

Firstly, according to a first embodiment, it is determined whether the portable device for storing the personal health record is supplied with power. When it is confirmed that the portable device for storing the personal health record is supplied with power, it may be determined that the connection unit 10 is connected to a terminal capable of supplying power, i.e., a personal computer, portable phone, or the like.

When it is recognized that the main body 20 of the portable device for storing the personal health record is supplied with power, an operation for inputting biometric information for user authentication is performed. When the biometric information for the user authentication is inputted, an operation for comparing a biometric signal inputted for the user authentication with prestored biometric information is performed.

Herein, the prestored biometric information is stored in the storage module 60 to be compared with the biometric signal inputted through the security module 40.

When the biometric signal inputted through the security module 40 matches the biometric information inputted to the storage module 60, the control module 70 determines that the user authentication is successful.

When the control module 70 determines that the user authentication is successful, the control module 70 permits data read and write functions so that both of the public data and private data may be used.

On the contrary, when the biometric signal inputted through the security module 40 does not match the biometric information inputted to the storage module 60, the control module 70 determines that the user authentication fails.

When the control module 70 determines that the user authentication fails, the control module 70 permits a function of reading the public data so that the public data may be accessed.

Herein, in the case where the control module 70 determines that the user authentication is successful, a personal viewer having function of data read and write is executed so that both of the public data and private data may be used. The personal viewer enables the user to add information to, revise, or delete the personal health record in order to manage the personal health record.

Then, when the operation of addition, revision, or deletion is performed by the personal viewer, an operation of storing an access record is performed. When it is determined that the personal health record management or the storing of the access record is completed, an operation for terminating a personal health record management system is performed.

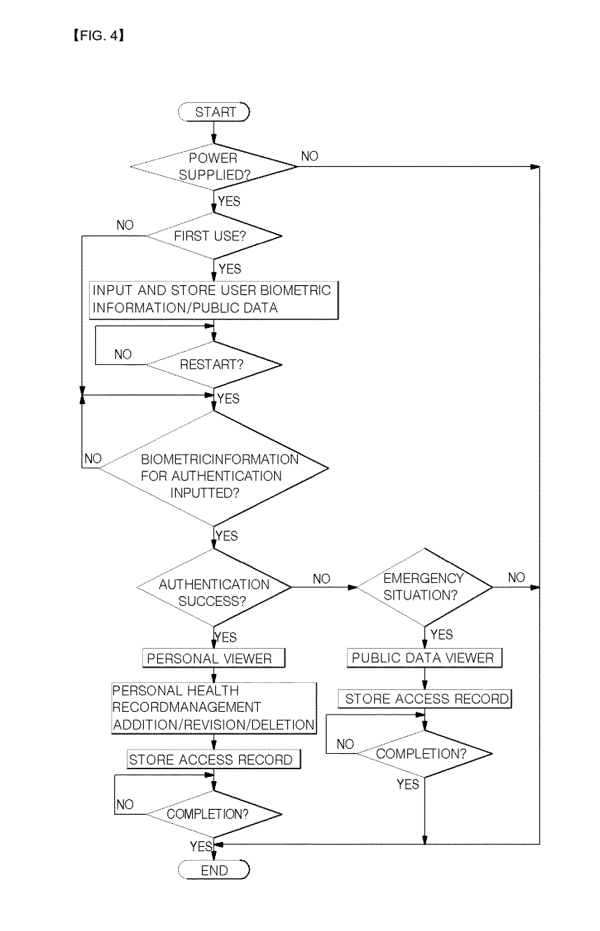

Hereinafter, operations of the portable device for storing the personal health record according to the first use thereof will be described with reference to FIG. 4.

FIG. 4 is a flowchart illustrating the operations of the portable device for storing the personal health record according to an embodiment when the portable storage device is used for the first time.

Firstly, it is determined that the main body 20 is supplied with power. When it is determined that the main body 20 is supplied with power, it is determined that the connection unit 10 is connected to the terminal of the user.

When it is determined that the main body 20 is supplied with power, the control module 70 determines whether the main body 20 is used for the first time. Herein, the control module 70 determines whether the biometric information for the user authentication is stored in the storage module 60 to thereby determine whether the main body 20 is used for the first time.

When the control module 70 determines that the main body 20 is used for the first time, the control module 70 performs operations for inputting the biometric information for the user authentication and for inputting the public data.

When the user authentication fails, the control module 70 determines whether the user is in an emergency situation. In the case of an emergency situation, the control module 70 executes a public data viewer for viewing the public data. In the case of a nonemergency situation, the personal health record management system is terminated.

When the biometric information for the user authentication is completely inputted and stored in the storage module 60, the control module 70 restarts the main body 20 to complete the storing of the public data and the biometric information for the user authentication in the storage module 60.

When the main body 20 is operated in the state where the storing of the public data and the biometric information for the user authentication in the storage module 60 is completed due to the restart of the main body 20, an operation for determining whether biometric information for the user authentication is inputted is performed.

When the biometric information for the user authentication is inputted, it is determined whether the user is authorized. In the case of successful authentication, the personal viewer for managing the personal health record is executed. In the case of failed authentication, it is further determined whether the user is in an emergency situation.

In the case of an emergency situation, the public data viewer is executed to view the public data, and the operations are completed after storing the access record. As described above, by viewing the public data, efficiency of emergency treatment is improved, and the emergency treatment is suitable for characteristics of the user.

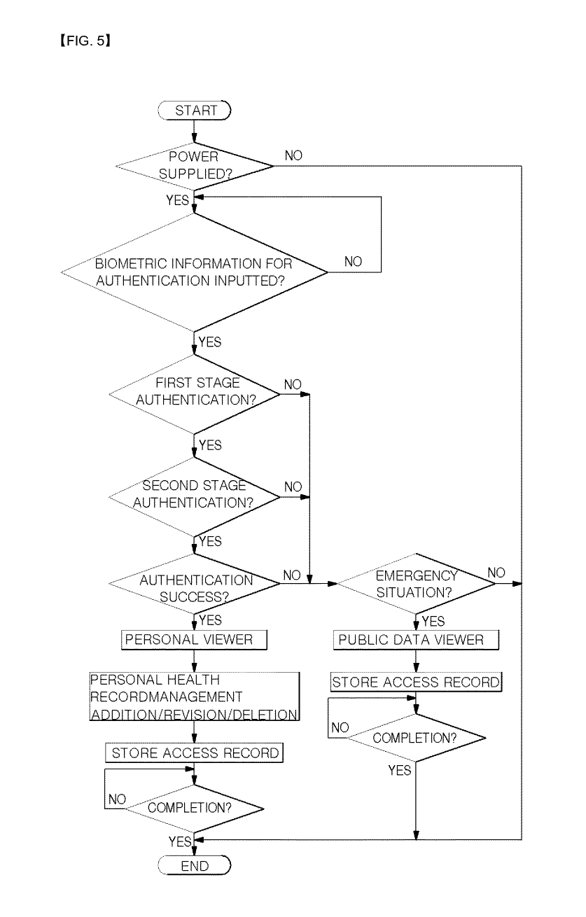

Hereinafter, another embodiment will be described with reference to FIG. 5. FIG. 5 is a flowchart illustrating operations of the portable device for storing the personal health record according to another embodiment.

In FIG. 5, it is illustrated that the user authentication is performed in multiple stages.

The multistage user authentication is for preventing the misuse of the personal health record when the user is unconscious. Processes of the multistage user authentication will be described in detail. The control module 70 determines whether the main body 20 is supplied with power.

When it is determined that the main body 20 is supplied with power, the control module 70 determines whether the biometric signal for the user authentication is inputted through the security module 40.

Herein, when it is determined that the main body 20 is not supplied with power, the control module 70 terminates the operations to prevent the main body 20 from being used.

When it is determined that the biometric signal for the user authentication is inputted, the control module 70 performs first stage authentication. For the first stage authentication, the biometric information stored in the storage module 60 is compared to the biometric signal inputted through the security module 40 to determine whether the biometric information matches the biometric signal inputted.

In the embodiment, the multistage user authentication is such configured that each fingerprint of the user is stored and then the fingerprints are verified in preset order of, e.g., a thumb and an index finger.

As a matter of course, the order may also be a thumb and a ring finger or a thumb and a middle finger. Further, the multistage user authentication may also be such configured as to recognize the fingerprint of a thumb and the iris pattern.

Meanwhile, when the biometric signal inputted through the security module 40 matches the first stage biometric information stored in the storage module 60 at the first stage authentication, the control module 70 performs second stage authentication.

When it is determined that the first stage biometric information does not match the first stage biometric signal inputted through the security module 40, the control module 70 determines that the user fails to be authorized.

When the user authentication fails, the control module 70 determines whether a current situation is an emergency situation. In the case of an emergency situation, the control module 70 executes the public data viewer so that the public data stored in the public storage module 61 may be accessed.

For the second stage authentication, the biometric signal inputted through the security module 40 is compared to second stage biometric information stored in the storage module 60.

When it is determined that the biometric signal inputted through the security module 40 matches the second stage biometric information stored in the storage module 60, the control module 70 determines that the authentication is successful and executes the personal viewer for performing data read and write operations on the public storage module 61 and the private storage module 62.

When the biometric signal does not match the second stage biometric information stored in the storage module 60, the control module 70 determines that the user authentication fails and determines whether a current situation is an emergency situation.

That is, the control module 70 determines whether a current situation is an emergency situation. In the case of an emergency situation, the control module 70 executes the public data viewer so that the public data stored in the public storage module 61 may be accessed.

As described above, by determining whether the user is authorized in multiple stages, the security is more improved and the leakage of the personal health record is prevented.

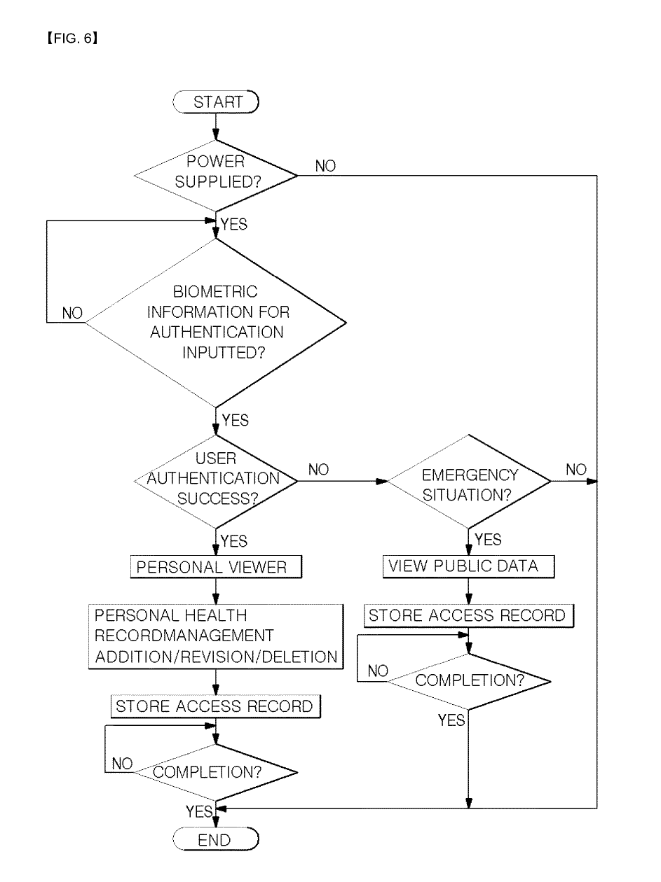

FIG. 6 is a flowchart illustrating operations of the portable device for storing the personal health record according to another embodiment.

Referring to FIG. 6, when it is determined that the biometric signal inputted through the security module 40 matches the biometric information stored in the storage module 60 and thus the user authentication is successful, the control module 70 executes the personal viewer for performing data read and write operations on the storage module 60.

On the contrary, when it is determined that the biometric signal inputted through the security module 40 does not match the biometric information stored in the storage module 60 and thus the user authentication fails, the control module 70 determines whether a current situation is an emergency situation. In the case of an emergency situation, the control module 70 executes the public data viewer so that the public data stored in the public storage module 61 may be accessed.

For the second stage authentication, the biometric signal inputted through the security module 40 is compared to second stage biometric information stored in the storage module 60.

When it is determined that the biometric signal inputted through the security module 40 matches the second stage biometric information stored in the storage module 60, the control module 70 determines that the authentication is successful and executes the personal viewer for performing data read and write operations on the public storage module 61 and the private storage module 62.

Since the personal health record is managed by using the personal viewer, the management state of the personal health record may be detected on the basis of the access record stored by the control module 70. When the management of the personal health record is completed, an operation for terminating the use of the main body 20 is performed.

Further, when the control module 70 determines that the user authentication fails, the operation for terminating the use of the main body 20 is performed. As described above, the portable device for storing the personal health record has enhanced security ability, thereby preventing the leakage of the personal health record.

Meanwhile, when the user authentication fails, an operation for requesting input of a password may be further performed. That is, when an inputted password matches a password stored in the security module 40, the user is allowed to read the public data stored in the public storage module 61.

Herein, this operation may also be such configured that a biometric signal is inputted instead of the password. That is, this operation is such configured that a first aider may access a public personal health record, e.g., the public data stored in the public storage module 61, when the owner of the portable storage device, i.e., the authorized user, has an emergency and thus cannot use the personal health record.

In other words, in the case where the user is not the owner, the user is enabled to access the public data by confirming the password or inputting information of the user so that efficient and appropriate emergency treatment may be given by using the public data of the personal health record in an emergency.

In this case, the history of the use of the personal health record may be detected by storing the access record, and the management of the personal health record may also be possible.

Accordingly, applicability and usability of the portable device for storing the personal health record is improved.

### INDUSTRIAL APPLICABILITY

According to the portable device for storing the personal health record according to the embodiments, the leakage of the personal health record is prevented, and the management of the personal health record is easy.

Due to these various effects, the portable device for storing the personal health record according to the embodiments can be applied not only in medical industry but also other related industries.

1. A portable device for storing a personal health record, the portable device comprising:
a connection unit configured to be connected to a personal terminal and provide paths for supplying power and transmitting data;
a main substrate configured to be connected to the connection unit, fix a plurality of elements, and transmit electric signals through a printed circuit;
a security module configured to be mounted on the main substrate, and determine whether a user is authorized based on biometric information of the user;
a communication module configured to be mounted on the main substrate, receive measurement data by means of near field communication from a measurement device measuring a health condition of an individual;
a storage module configured to be mounted on the main substrate and store data; and
a control module configured to control the main substrate and each of the modules,
wherein the storage module comprises:
a public storage module configured to store data inputted by an authorized user; and
a private storage module configured to store the measurement data received from the communication module.

2. The portable device according to claim 1, wherein the communication module and the storage module transmit and receive data to and from the main substrate by using RS-232 technique.

3. The portable device according to claim 1, wherein the security module determines whether a current situation is an emergency situation when the user is not authorized to determine whether to enable the public data to be accessed.

4. A method for controlling a portable device for storing a personal health record, the method comprising:
comparing biometric information inputted for user authentication with biometric information stored in a security module mounted on a main substrate;
permitting functions of read and write when the inputted biometric information matches the biometric information stored in the security module and the user authentication is successful so that private data stored in the storage module and public data are allowed to be used, wherein the private data are transmitted from a measurement device measuring a biometric signal to a communication module by means of wireless communication to be stored in the storage module; and
permitting the function of read in the case of an emergency situation after determining whether a current situation is the emergency situation if the inputted biometric information does not match the biometric information stored in the security module and the user authentication fails.

5. The method according to claim 4, comprising:
inputting the biometric information to be used for the user authentication into the security module mounted on the main substrate;
inputting the public data which are accessible into a public storage module of the storage module mounted on the main substrate when the main substrate is supplied with power; and
restarting the main substrate and each module mounted thereon when the inputting of the biometric information and the public data is completed.

6. The method according to claim 5, comprising:
comparing other pieces of biometric information of the user inputted in multiple stages with the biometric information stored in the security module during the user authentication and determining whether the data stored in the storage module are used.

7. The method according to claim 5, comprising:
requesting input of user information when the user authentication fails; and
storing the inputted user information and permitting the function of read so that the public data are accessible.
